(19) United States
(12) Patent Application Publication
(10) Pub. No.: US 2020/0180503 A1
(43) Pub. Date: Jun. 11, 2020

(54) ENERGY-EFFICIENT LIGHTING SYSTEM FOR AUTONOMOUS VEHICLES

(71) Applicant: Flex-N-Gate Advanced Product Development, LLC, Tecumsech (CA)

(72) Inventors: Rick Buyck, Belleville, MI (US); Brandon Richards, Detroit, MI (US); Suhas Purkar, Farmington Hills, MI (US); Steve Wichmann, Saline, MI (US)

(21) Appl. No.: 16/705,716

(22) Filed: Dec. 6, 2019

Related U.S. Application Data
(60) Provisional application No. 62/776,011, filed on Dec. 6, 2018.

(51) Int. Cl. B60Q 1/14; G05D 1/00

(52) U.S. Cl. CPC B60Q 1/143; B60Q 2300/41; G05D 1/0088

(57) ABSTRACT

Disclosed are a system and a process for controlling the exterior lighting of an autonomous vehicle using autonomous modes of operation detected. In some modes, certain forms of exterior lighting normally required in manual operation are not necessary when the vehicle is in particular modes. Because of this, a control system is configured to dim or deactivate the headlights when one autonomous vehicle is following another autonomous vehicle. Similarly, taillights can be dimmed or turned off where an autonomous vehicle is leading another autonomous vehicle. This, in one respect, serves to conserve energy.

### CROSS-REFERENCE TO RELATED APPLICATIONS

This application claims the benefit of U.S. Provisional Application No. 62/776,011 filed on Dec. 6, 2018, the entire contents of which are hereby incorporated by reference.

### BACKGROUND

### 1. Field of the Disclosure

Embodiments of this disclosure relate generally to the field of illumination systems and methods for vehicles. More specifically, embodiments of this disclosure relate to the operation of lighting systems of autonomous vehicles in the interest of efficiency.

### 2. Description of the Related Art

Systems that modify the mode of operation for a vehicle's lighting system based on sensed information have been known. For example, in U.S. Pat. No. 6,947,576 issued to Stam et al., a system is disclosed where exterior vehicle lights are automatically controlled in response to various conditions to reduce glare. An example of the system used is disclosed in prior art FIG. 1, which is not an actual figure from the patent, but is intended as a summarized high-level depiction of the system. Referring to the figure, it can be seen that a system 10 includes light sensors 12, glare sensors 13, a microcontroller 14, and light drivers 16, all used to control the vehicle headlights 18.

Stam also discloses a process 20 generally described in FIG. 2. FIG. 2, again, is not an exact copy of any figure in Stam, but gives a description of some of the processes disclosed. The Stam process 20, begins with a step 22, then moves on to a step 24 where available light is measured. Next, in a step 26, a determination is made as to whether the headlights are in auto mode or not. If the headlights are not in auto mode, the process moves back to the measurement step 24. If, however, the lights are in auto mode, the process moves on from step 26 to a step 28 where it is determined whether ambient light is below a minimal threshold. If the light is above the minimum, the process returns to a step 24. If the light level is above the threshold, the process moves on to a step 30 and the lights are turned on. After that, in a step 32, glare is measured. Then, in a step 34, based on the glare measured, the light settings are set to a particular state. For example, different lights can be turned on and off, and lights can be dimmed based on the conditions, e.g., glare.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages will be apparent from the following detailed description of the embodiments and the accompanying drawing figures.

A lighting system for an automated vehicle is disclosed. The system, in embodiments, includes a controller. The controller can be configured to receive an automated status of the vehicle, the automated status relating to a location of the vehicle in a surrounding environment, the controller further adapted to modify an exterior lighting condition in response to the automated status received.

In embodiments, the controller either activates, deactivates, or dims an exterior light to modify the exterior lighting condition. The automated status can relate to the surrounding environment due to the vehicle's position relative to another vehicle. In embodiments, the exterior light is a headlamp, and the automated status reflects a following position behind a forward automated vehicle having an active headlamp. In other embodiments, the controller is configured to, upon receiving an automated mode indicating a leading position ahead of a following automated vehicle, either deactivate or dim taillight illumination. In some versions the controller is configured to optionally activate, dim, or deactivate both headlights and taillights in response to the automated status received.

In some instances the automated status relates to the surrounding environment in regards to a position relative to at least one other vehicle, but the status may relate to an environmental location in regards to the vehicle being located in an environment where there is an absence of other vehicles and thus little light is required for safe operation.

Processes are also disclosed. In one embodiment, a disclosed process involves operating at least one light on a vehicle. More specifically, the process involves configuring a system on the vehicle to operate according to a standard lighting setting when the vehicle is being operated in a manual mode; detecting when the vehicle is being operated automatically; receiving an automated mode of the vehicle, the automated mode relating to a relative position of the vehicle; and modifying an illumination condition of the light in response to the automated mode received.

In some embodiments, (i) activating, (ii) deactivating, or (iii) dimming are the modifications made to illumination. In other embodiments, upon receiving an automated mode regarding the vehicle's position in a row of a group of vehicles, the mode making the illumination by the at least one light less necessary, either dimming or deactivating the light for the purpose of avoiding energy consumption. Upon receiving an automated mode indicating a forwardmost vehicle position, the process can either deactivate or dim taillight or headlight illumination.

Also disclosed is a vehicle arrangement. More specifically, the vehicle can include an Automated Vehicle Control Module (AVCM), a Lighting Control Module (LCM), a headlight and a taillight, both the headlight and the taillight being configured to be either activated, deactivated, or dimmed by the LCM; and a controller, the controller configured to receive an Autonomous Vehicle (AV) mode from the AVCM, and cause the LCM to one of activate, deactivate, or dim one of the headlight or taillight upon recognition of the AV mode.

### BRIEF DESCRIPTION OF THE DRAWINGS

Illustrative embodiments of the present disclosure are described in detail below with reference to the attached drawing figures, which are incorporated by reference herein and wherein:

FIG. 1 is a prior art system;

FIG. 2 is a prior art process executed along with the system of FIG. 1;

FIG. 3 is system diagram for an embodiment;

FIG. 4 is a high-level flow diagram showing the steps for one embodiment;

FIG. 5 is a more detailed flow diagram showing the processes for an embodiment; and

FIG. 6 is an overhead view of vehicles on a road showing how the processes and systems might be used.

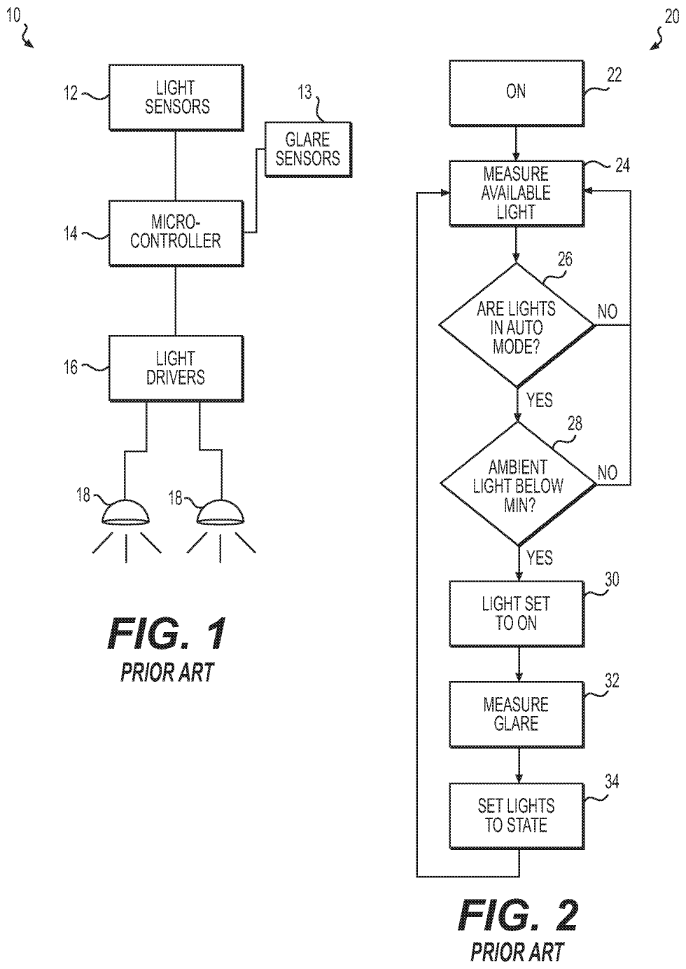

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

Disclosed is a system and method operational with autonomously driven vehicles. Autonomous vehicles normally can be driven in manual or autonomous modes. When a vehicle is driven an autonomous mode, it has been discovered herein that there are circumstances where forward lighting and other kinds of lighting may or may not be necessary for safe and/or proper vehicle operation. In view of that, the lighting systems of these vehicles can also be controlled to reduce energy consumption while still meeting legal standards. Depending on applications, lighting selections can be automated based on what particular mode of automation the vehicle is in. That mode may depend on where the vehicle is positioned relative to other vehicles operating automatically. For example, for a vehicle traveling as a front car in a line of automated vehicles, headlights will be necessary, but tail lights may not if the following car is being automatically driven. A vehicle in a middle vehicle mode may need no headlights or tail lights. And a tail end car in the line may need no headlights, but might require taillight activation.

The effected changes might involve turning off unnecessary exterior lighting completely, turning off sections of the exterior lighting, dimming exterior lighting, and executing combinations thereof.

These functions could be controlled in a variety of ways. For example, lighting functions can be controlled by a LED Driver Module (LDM), or via vehicle communications regarding what is optimal when the vehicle is in an autonomous mode.

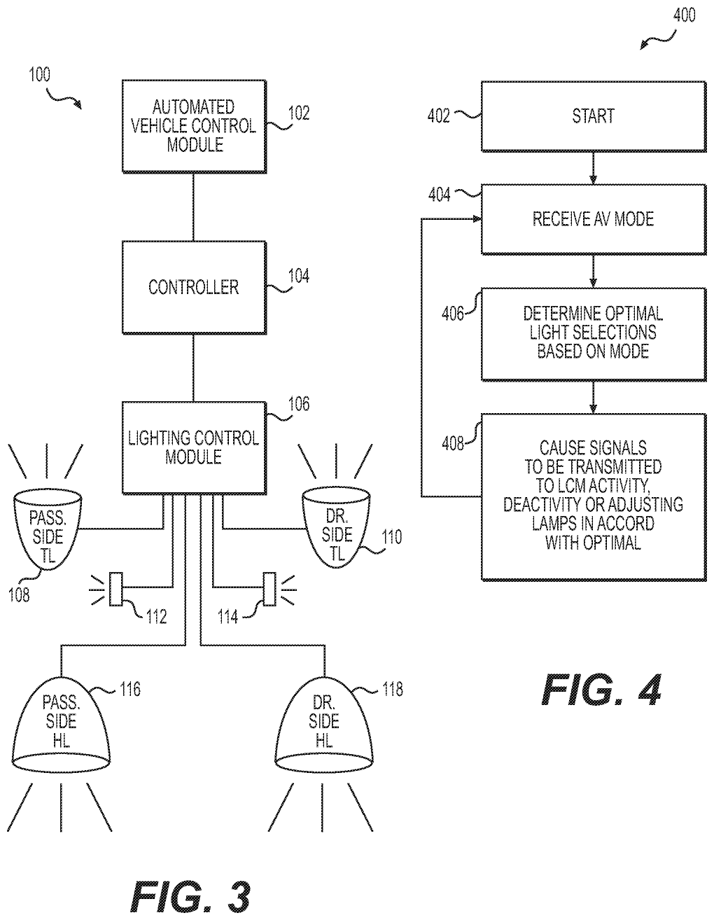

FIG. 3 shows one system embodiment 100 for a vehicle in which the above described processes might be executed. The FIG. 3 system includes an Automated Vehicle Control Module (AVCM) 102. Those skilled in the art will recognize that the AVCM can take many various forms, be a combination of separate systems, can include the use of both on-board wired, as well as wirelessly received communications. Regardless, the AVCM institutes commands to the vehicle systems, e.g., the mode of operation the vehicle is to be in, etc., so that the vehicle is automatically driven.

The AVCM 102, in embodiments, communicates with at least one controller 104 on the vehicle. The controller 104 may be a computing device on the vehicle, and may use information received from the AVCM 102 to implement vehicle functions. Functions relating to lighting are handled more specifically by a Lighting Control Module (LCM) which, in embodiments, switches lights on and off and handles dimming. Here, the LCM receives inputs from the controller 104 to activate, deactivate, and adjust the intensity of any number of lights. In the embodiment disclosed in FIG. 3, the vehicle has a passenger side taillight 108, a driver's side taillight 110, a passenger's side lateral light 112, a driver side lateral light 114, a passenger's side headlamp 116, and a driver's side headlamp 118. It should be understood that although a particular lighting arrangement is shown in FIG. 3, that most modern vehicles would include numerous other lighting systems which could be included in a system incorporating the concepts disclosed herein.

FIG. 4 discloses a high-level process 400 illustrative of an embodiment of the invention. Starting at a first step 402, the process moves on to a step 404, where the controller 104 receives an Autonomous Vehicle (AV) mode in which the vehicle is intended for operation. The reference to “mode” could entail any sort of automated status the vehicle might be put in. For example, the mode might be positional relative to other vehicles, e.g., is operating independently, or traveling along with other AVs. If traveling with a group of AVs, it is contemplated that the group will travel in a line to avoid other non-AV traffic. Where this occurs, the AV mode might be different for a lead vehicle, a vehicle traveling in the middle of the line, or a rearmost vehicle in the line. Other examples for modes exist relating to positional status of the vehicle. For example, other additional possible lighting modes can be used to benefit energy consumption, or for other purposes, where position is relevant to the need for the lighting of co-traveling AVs. Further, alternative modes might exist for situations not relating to the relative position of the vehicle. For example, relative position could be used by the process to trigger AV/PS modes that would include dimming where other vehicles are detected as oncoming.

It is possible that the processes of FIG. 4 are operating on the controller 104, but alternatively these processes could operate at the LCM 106, or even be incorporated into the AVCM 102. Thus, unless otherwise specified in the claims, the execution of the process should not be limited to being performed by any particular computer system.

In a next step 406, a determination is made (either by controller 104, a logic controller, or some other computer system) as to what lighting arrangement would be optimal for the vehicle. For example, it might make sense to turn off some of the lights, turn some on, and dim others. This optimization can be done with an eye towards energy efficiency since duplicitous or unnecessary lighting operations would consume energy unnecessarily.

Once an optical arrangement is determined in step 406, the process moves on to a step 408 where signals are transmitted to the LCM 106 activating, deactivating, or adjusting the intensity level of lights (e.g., taillights 108 and 110, lateral lights 112 and 114, and headlamps 116 and 118) to avoid using energy associated with unnecessary lighting, or for other purposes.

Following step 408, the process returns to step 404 for receiving an autonomous vehicle mode. In this manner, the process proceeds with steps 406 and 408 in a continuous loop such that when the mode of operation of the vehicle is changed, the lighting selections and activations/deactivations/dimming are also automatically changed accordingly.

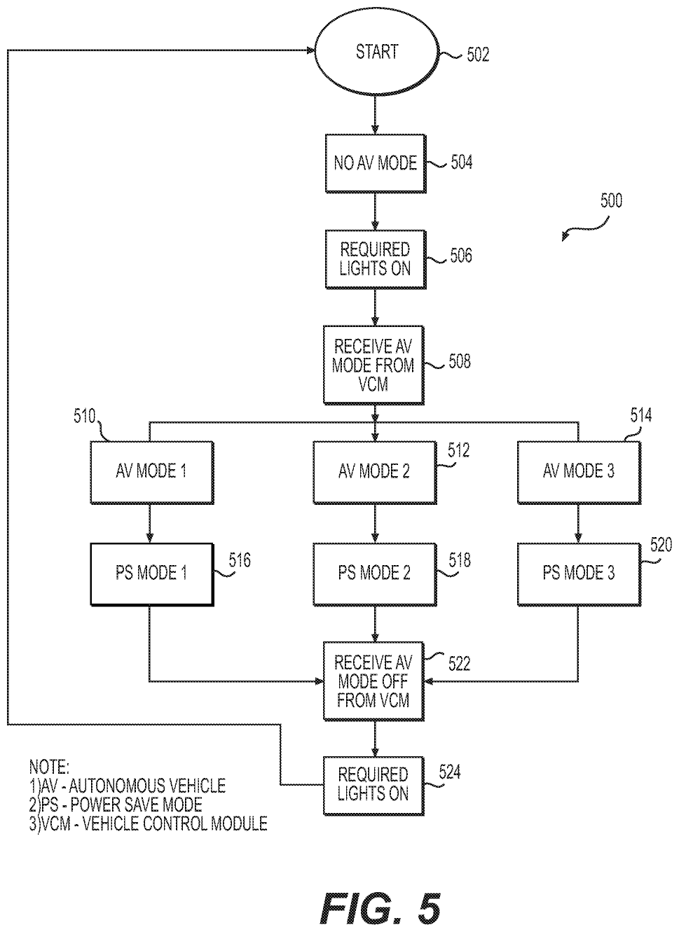

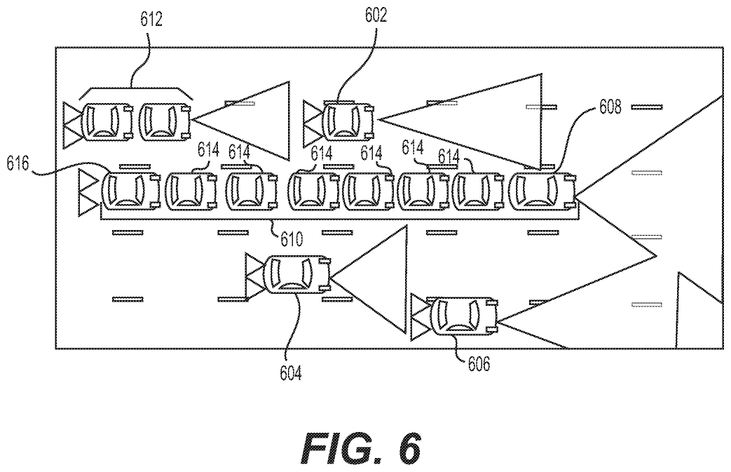

FIG. 5 is a more detailed process flow diagram 500 embodying the concepts expressed herein. Starting with a step 502, the process moves on to a step 504 where a determination is made as to whether the vehicle is in any automated mode at all. If not, all of the lights normally required for the vehicle when it is operating normally are turned on. For example, for normal manual driving at night, vehicle 100 might have all of lights 108, 110, 112, 114, 116, and 118 illuminated. Thus, in a step 506, after learning that the vehicle is in manual mode, these lights are turned/remain on to be in a fully-operated state as would ordinarily occur. Vehicles 602, 604, and 606 shown in FIG. 6 can be seen as operating in manual mode, and thus, must maintain ordinary lighting as shown.

But from an energy-consumption standpoint, these lights may not be necessary where a vehicle is in some form of completely or even partial automatic control. Thus, in a next step 508, an AV mode is received into the controller 104 from the AVCM 102. Those skilled in the art will recognize that numerous modes exist. Next, the process detects if any one of a plurality of AV modes exist. In the embodiment disclosed in FIG. 5 three modes are shown: AV mode 1 (510); AV mode 2 (512); and AV mode 3 (514). Each of these modes will reflect some status of operation of the vehicle. As discussed above, the mode might be related to a position of the vehicle relative to other vehicles on the highway. Where the vehicle is one of a plurality of vehicles traveling in a same direction, all at substantially similar speeds, there might be three different modes. For example, AV mode 1 (510) might relate to the operation of a vehicle in the front of a line of vehicles 610 (see, e.g., vehicle lines 610 and 612 shown in FIG. 6). AV mode 2 (512) might be related to the operations of a center vehicle (e.g., any of a group of center vehicles 614 shown in FIG. 6) if located at a position between the front and rear vehicles 608 and 616, respectively. And an AV mode 3 (514) might be indicative of an operational status of a vehicle at the rear of the line (e.g., rear vehicle 616).

For each AV mode, there exists a designated lighting mode, more specifically in embodiments, three separate Power Save (PS) modes. For the front vehicle AV mode 1 (510), there is a corresponding PS mode 1 (516). Looking to FIG. 6 it can be seen that PS/lighting mode 516 might include illuminating only the headlamps and side lights as shown with respect to front car 608. For center vehicle mode AV mode 2 (512), there is a corresponding PS/lighting mode 2 (518) which may involve only illuminating the vehicles side lamps. In FIG. 6, each of the middle cars 614 are in middle car mode PS mode 2 (512). For AV mode 3 rear-vehicle mode, a PS mode 3 (520) is implemented where, e.g., only the taillights and side lights are illuminated. As an illustration, rear vehicle 616 in FIG. 6 is shown as being in PS mode 3 (520).

In a step 522, the particular lighting arrangement corresponding to the particular PS mode is included in a signal which is received into the LCM 106 from the controller 104. LCM 106 then causes the appropriate modifications to the existing lighting (e.g., turns off unnecessary lamps, dims lamps, and/or modifies the intensity, etc.), and leaves only the required lighting on in a step 524. The process repeats by then looping back to start 502.

The modes described in FIG. 5 and the results illustrated in FIG. 6 are only examples. In reality, far more AV modes and corresponding PS modes would exist for the typical vehicle. For example, the front and rear cars could include automatically illuminated signs indicating the status of the line as collectively being in automated driving mode rather than in manual. Further, the position of a subject vehicle might be compared against the position of a more forward vehicle, and based on distance, the exterior headlamps could be dimmed to avoid glare experienced by the vehicle ahead.

It should be noted that the processes depicted in FIG. 5 would most likely operate on the controller 104, but alternatively could be executed on the LCM 106, or incorporated into the AVCM 102. Thus, unless otherwise specified in the claims, the execution of the process should not be limited to being performed by any particular computer system.

Also, the lighting arrangement for an actual vehicle today has, of course, more complexity than is shown in FIG. 3. Thus, other lighting components not shown in FIG. 3 are likely to be operated according to different lighting/PS modes.

Also noteworthy is that the modes shown in FIG. 5 are far fewer than would likely exist in a system actually implemented. They are expressed only to illustrate an embodiment. For example, all of the embodiments shown in the figures regard the location of one automated vehicle in relation to others (e.g., position in a line), but it should also be recognized that light dimming, deactivations, or other adjustments can be done where an autonomous mode indicates a time when full power lighting may not be needed. One example of such a situation occurs when the vehicle is detected as being on a highway in a remote low-traffic area where there is a high confidence in safety performance with limited lighting. Other additional possible operational modes exist where the dimming or deactivating features herein can be utilized to save energy, avoid glare, or for some other purpose.

Features described above as well as those claimed below may be combined in various ways without departing from the scope hereof. The following examples illustrate some possible, non-limiting combinations:

(A1) A lighting system for an automated vehicle includes a controller that is configured to receive an automated status of the vehicle. The automated status relates to a location of the vehicle in a surrounding environment. The controller is further adapted to modify an exterior lighting condition in response to the automated status received.

(A2) For the lighting system denoted as (A1), the controller may be configured to activate, (ii) deactivate, or (iii) dim an exterior light to modify the exterior lighting condition.

(A3) For the lighting system denoted as either (A1) or (A2), the automated status relating to the surrounding environment may be regarded as a position relative to at least one other vehicle.

(A4) For the lighting system denoted as any of (A1) through (A3), the exterior light may be a headlamp, and the automated status may reflect a following position behind a forward automated vehicle having an active headlamp.

(A5) For the lighting system denoted as any of (A1) through (A4), the controller may be configured to, upon receiving an automated mode indicating a leading position ahead of a following automated vehicle, either deactivate or dim taillight illumination.

(A6) For the lighting system denoted as any of (A1) through (A5), the controller may be configured to optionally activate, dim, or deactivate both headlights and taillights in response to the automated status received.

(A7) For the lighting system denoted as any of (A1) through (A6), the automated status relating to the surrounding environmental may be in regards to a position in a line including a plurality of vehicles.

(A8) For the lighting system denoted as any of (A1) through (A7), the automated status relating to the surrounding environment may be in regards to the vehicle being located in an environment where there is an absence of other vehicles and thus little light is required for safe operation.

(B1) A process for operating at least one light on a vehicle includes configuring a system on the vehicle to operate according to a standard lighting setting when the vehicle is being operated in a manual mode, detecting when the vehicle is being operated automatically, receiving an automated mode of the vehicle, the automated mode relating to a relative position of the vehicle, and modifying an illumination condition of the light in response to the automated mode received.

(B2) For the process denoted as (B1), the process may further include selecting one of: (i) activating, (ii) deactivating, or (iii) dimming as the illumination condition being modified.

(B3) For the process denoted as either of (B1) or (B2), upon receiving an automated mode regarding the vehicle's position in a row of a group of vehicles, the process may further include the mode making the illumination by the at least one light less necessary, either dimming or deactivating the light for the purpose of avoiding energy consumption.

(B4) For the process denoted as any of (B1) through (B3), upon receiving an automated mode indicating a forwardmost vehicle position, the process may further include either deactivating or dimming taillight illumination.

(B5) For the process denoted as any of (B1) through (B4), upon receiving an automated mode indicating a center vehicle position, the process may further include either deactivating or dimming headlight illumination.

(B6) For the process denoted as any of (B1) through (B5), the process may further include additionally either deactivating or dimming taillight illumination.

(B7) For the process denoted as any of (B1) through (B6), upon receiving an automated mode indicating a rear-most vehicle position, the process may further include either deactivating or dimming headlight illumination.

(C1) A vehicle includes an Automated Vehicle Control Module (AVCM), a Lighting Control Module (LCM), and a headlight and a taillight. Both the headlight and the taillight are configured to be either activated, deactivated, or dimmed by the LCM. A controller is configured to receive an Autonomous Vehicle (AV) mode from the AVCM and cause the LCM to one of activate, deactivate, or dim one of the headlight or taillight upon recognition of the AV mode.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Not all operations listed in the various figures need be carried out in the specific order described.

1. A lighting system for an automated vehicle comprising:
a controller, the controller configured to receive an automated status of the vehicle, the automated status relating to a location of the vehicle in a surrounding environment, the controller further adapted to modify an exterior lighting condition in response to the automated status received.

2. The system of claim 1 wherein the controller is configured to activate, (ii) deactivate, or (iii) dim an exterior light to modify the exterior lighting condition.

3. The system of claim 1 wherein the automated status relating to the surrounding environment regards a position relative to at least one other vehicle.

4. The system of claim 3 wherein the exterior light is a headlamp, and the automated status reflects a following position behind a forward automated vehicle having an active headlamp.

5. The system of claim 3 wherein the controller is configured to, upon receiving an automated mode indicating a leading position ahead of a following automated vehicle, either deactivate or dim taillight illumination.

6. The system of claim 1 wherein the controller is configured to optionally activate, dim, or deactivate both headlights and taillights in response to the automated status received.

7. The system of claim 1 wherein the automated status relating to the surrounding environment regards a position in a line including a plurality of vehicles.

8. The system of claim 1 wherein the automated status relating to the surrounding environment regards the vehicle being located in an environment where there is an absence of other vehicles and thus little light is required for safe operation.

9. A process for operating at least one light on a vehicle, the process comprising:
configuring a system on the vehicle to operate according to a standard lighting setting when the vehicle is being operated in a manual mode;
detecting when the vehicle is being operated automatically;
receiving an automated mode of the vehicle, the automated mode relating to a relative position of the vehicle; and
modifying an illumination condition of the light in response to the automated mode received.

10. The process of claim 9 comprising:
selecting one of: (i) activating, (ii) deactivating, or (iii) dimming as the illumination condition being modified.

11. The process of claim 10 comprising:
upon receiving an automated mode regarding the vehicle's position in a row of a group of vehicles, the mode making the illumination by the at least one light less necessary, either dimming or deactivating the light for the purpose of avoiding energy consumption.

12. The process of claim 11 comprising:
upon receiving an automated mode indicating a forwardmost vehicle position, either deactivating or dimming taillight illumination.

13. The process of claim 11 comprising:
upon receiving an automated mode indicating a center vehicle position, either deactivating or dimming headlight illumination.

14. The process of claim 13, comprising:
additionally either deactivating or dimming taillight illumination.

15. The process of claim 11 comprising:
upon receiving an automated mode indicating a rear-most vehicle position, either deactivating or dimming headlight illumination.

16. A vehicle comprising:
an Automated Vehicle Control Module (AVCM);
a Lighting Control Module (LCM);
a headlight and a taillight, both the headlight and the taillight being configured to be either activated, deactivated, or dimmed by the LCM; and
a controller, the controller configured to receive an Autonomous Vehicle (AV) mode from the AVCM, and cause the LCM to one of activate, deactivate, or dim one of the headlight or taillight upon recognition of the AV mode.
